(19) United States
(12) Patent Application Publication
(10) Pub. No.: US 2011/0209371 A1
(43) Pub. Date: Sep. 1, 2011

(54) DISPLAY DEVICE AND METHOD FOR SHIPPING CONTAINERS

(76) Inventor: WILLIAM H. TAYLOR, MT. PLEASANT, SC (US)

(21) Appl. No.: 13/037,143

(22) Filed: Feb. 28, 2011

Related U.S. Application Data
(60) Provisional application No. 61/308,603, filed on Feb. 26, 2010.

(51) Int. Cl. G09F 7/04; G09F 7/00; G09F 19/00

(52) U.S. Cl. 40/600; 40/603

(57) ABSTRACT

A device that is removably attached to one or both broad sides of a shipping container. The device provides a surface that occupies a substantial portion of the broad side of the container. The device may be used to present signage or other indicia that is positioned on the side of the container by means of the device. This device may be used to present advertising and other indicia or information by way of containers that are in transit, or by way of containers that are retired from shipping and are utilized for storage and other uses. The device comprises efficient fixation of the device by means comprising use of the containers' corner castings and/or door hinges. The invention provides an attachment that withstands wind and weather incurred during all modes of transportation. The flush and unobtrusive design of the surface and mounting devices of the invention do not interfere with commonly used container moving equipment or stowage practices.

### FIELD OF THE INVENTION

This invention relates to shipping containers and is more specifically related to a display device for attachment to shipping containers.

### BACKGROUND OF THE INVENTION

The container shipping industry came to maturity in the mid 20^{th} century with the advent of standardized boxes for all forms of maritime trade. Avoiding the long hours and labor involved with packing ships with break bulk cargo, containers were built to exacting measurements and requirements for the moving equipment used to move them.

Shipping containers adopted ISO standards in the 1990s that would ensure the worldwide shipping community used precisely the same parts and measurements to build all shipping containers. One important aspect of the ISO standards is the placement of cornercastings at each corner of a shipping container. These cornercastings are designed to accept twist lock hooks used to lift and maneuver containers at port and intermodal terminals.

Typically, containers are prepped with specific maritime paint that will remain on the container for the remainder of its useful life in the shipping business. Decals are also used for identification and to convey freight details (weight, hazardous, etc.) Decals and paint are generally reapplied as needed by container yard repair shops.

Containers are moved from point to point by truck and chassis, ship or intermodal trains. The equipment used to move containers from one mode of transportation to another all use the standardized cornercastings to lift the container.

Containers are assigned a general time period of usefulness in shipping when purchased by shipping companies or leasing companies. In many cases, containers are abandoned when the cost of moving them exceeds that of the container's value.

Once a container is no longer useful for shipping, they are converted to storage units. These storage units are commonly used by construction companies to store materials in a safe place on the job site. In other cases, these containers are converted to mobile command centers for the military or even homes for the underprivileged. The cornercastings generally remain with the container when employed for any use.

### SUMMARY OF THE INVENTION

The present invention is a device that is removably attached to one or both broad sides of a shipping container. The device provides a surface that occupies a substantial portion of the broad side of the container. The device may be used to present signage or other indicia that is positioned on the side of the container by means of the device. This device may be used to present advertising and other indicia or information by way of containers that are in transit, or by way of containers that are retired from shipping and are utilized for storage and other uses. The device comprises efficient fixation of the display device by means comprising use of the containers' cornercastings and/or door hinges. The invention provides an attachment that withstands wind and weather incurred during all modes of transportation. The flush and unobtrusive design of the surface and mounting devices of the invention do not interfere with commonly used container moving equipment or stowage practices. The easily removable properties of the invention allows the signage or advertising message to be refreshed from time to time.

### DESCRIPTION OF THE DRAWINGS

FIG. 1 shows a cornercasting that is exemplary of cornercastings as used with shipping containers.

FIG. 2 is a perspective view of an embodiment of the invention mounted to a broad side of a container.

FIG. 3A demonstrates an exploded view of one embodiment of the invention comprising a vinyl sheet with foam backing as mounted to an ISO container.

FIG. 3B demonstrates foam filler that may be used with the invention.

FIG. 4 is a partial view of a container and showing a trailing bracket comprising an elongated vertical axle.

FIG. 5A is a partial view of a ratchet embodiment that may be used with the invention.

FIG. 5B is a flat hook that is used with the ratchet shown in FIG. 5A.

FIG. 6A is a partial view of the leading bracket assembly.

FIG. 6B is a partial view of the trailing bracket assembly.

FIG. 7 is a partial view of an embodiment of the elongated axle a bead of a sheet of material inserted and held therein.

FIG. 8 shows views of the leading bracket as mounted in cornercastings of a container.

FIG. 9 shows views of the trailing bracket assembly mounted in cornercastings of a container.

FIG. 10 illustrates an embodiment of a retention hook.

FIG. 11 demonstrates elements of an embodiment of a ratchet assembly for the trailing bracket.

### DETAILED DESCRIPTION OF THE PREFERRED EMBODIMENTS

In a preferred embodiment, the present invention comprises a sheet of material 2 that extends along a broad side of a container 4 from near a front of a container to a near a rear of the container, and from a near a top of the container to a near a bottom of the container. The sheet of material covers substantially all of one or both broad sides of the container in a preferred embodiment. FIG. 2. In one embodiment, the sheet of material is formed and constructed to cover substantially all of a rectangular portion of a broad side of a shipping container, wherein the rectangular portion of the side of the shipping container is defined by four corner castings 6 of the shipping container. The sheet of material could cover a front or sides or top of the shipping container using the cornercastings for mounting as described herein, although there is less practicality in having signage on a top of a container, and the signage would cover doors on a rear.

The sheet of material is preferred to be pulled tight against the side of the container to reduce the adverse effects of air forced beneath the sheet of material induced by the movement during transport, such as the container travelling at highway speeds. Hook brackets 8 are used to hold the sheet of material tight and generally flush against the shipping container. The hook brackets 8 are preferred to be generally flush with the sides of the container. The leading bracket 10 and the trailing bracket 12 are preferred to be recessed within the sides of the container as shown in the drawings. The corrugated sides of the containers comprise valleys or recesses for positioning the leading bracket and the trailing bracket so that they are somewhat shielded from abuse and air flow. The leading bracket is preferred to extend substantially, but just less than, the entire vertical distance of the recess in the container in which it is mounted. The trailing bracket is preferred to extend substantially but just less than, the entire vertical distance of the recess in the container in which it is mounted. The sheet of material connects the leading bracket and the trailing bracket, and is pulled tight by the preferred winding mechanism and axle of the trailing bracket.

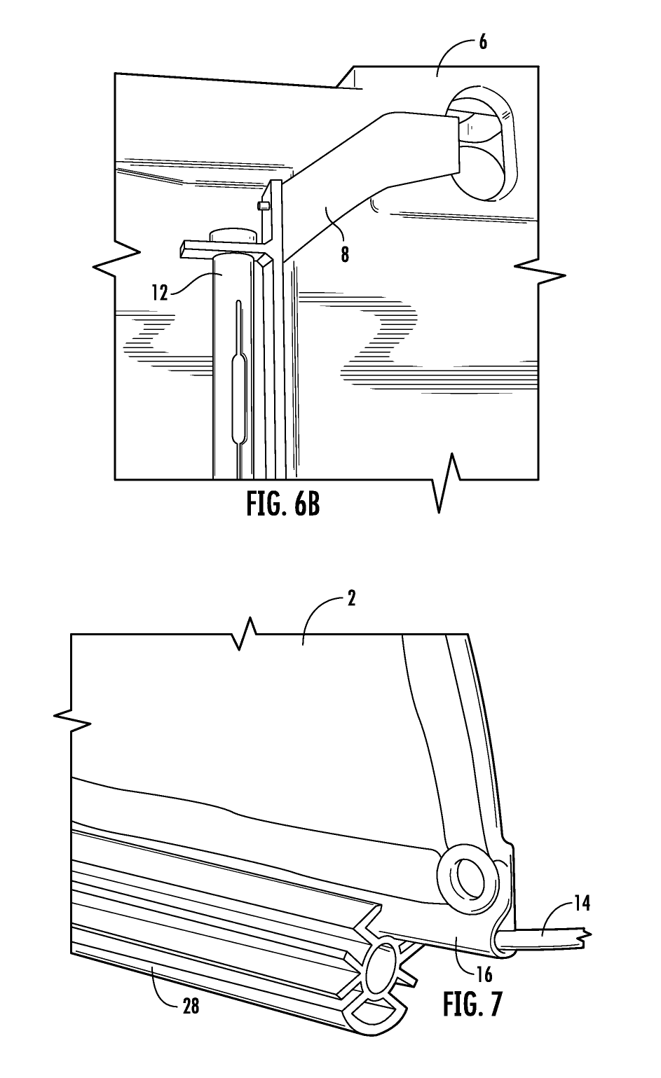

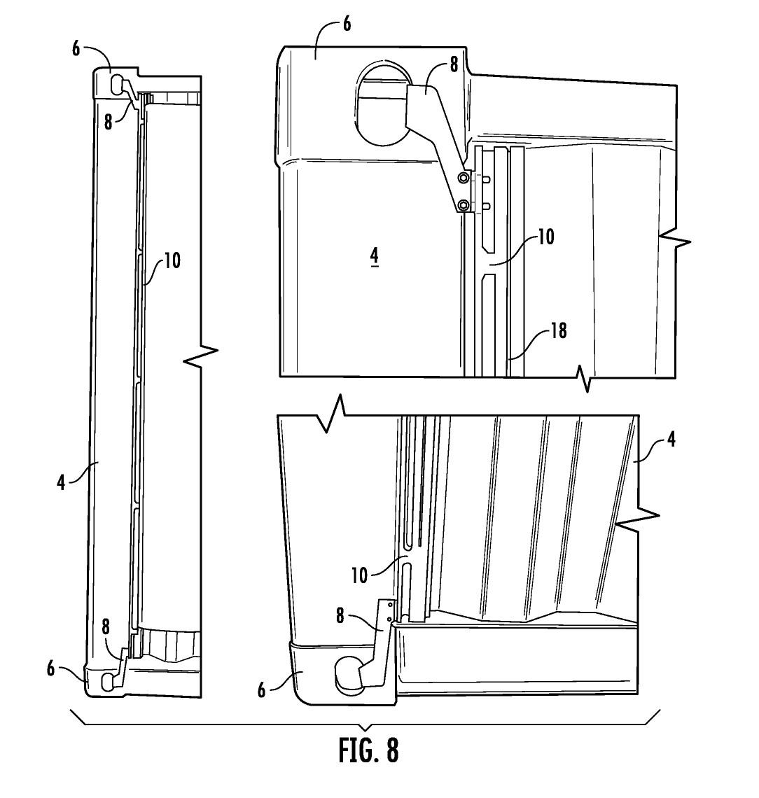

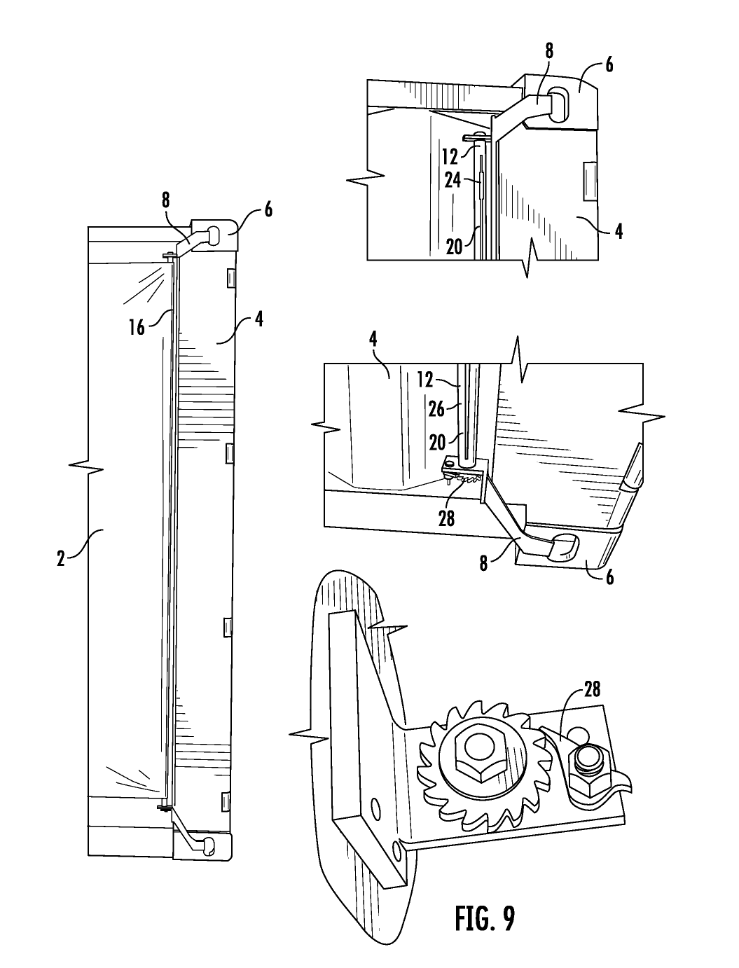

The hook brackets 8 have flat interior sides (the side that contacts the cornercasting) and exterior sides, to lay flat against the cornercastings and container. FIG. 6A; FIG. 6B; FIG. 8; FIG. 9. The hook brackets are constructed and arranged and attached to the leading edge to dispose the leading bracket into a recess in the side of the container. If the container has a corrugated side, the hook bracket will dispose the leading bracket into a valley in the side of the container. Similarly, the hook brackets are constructed and arranged and attached to the trailing bracket to dispose the trailing bracket into a recess in the side of the container. If the container has a corrugated side, the hook bracket will dispose the trailing bracket into a valley in the side of the container. The hook bracket may be constructed with an angle toward the recess or valley of the container, to position the bracket, and the associated axle and winding mechanism, into the recess. FIG. 9. Positioning the brackets and the sheet of material into the recess in the side of the container lessens exposure to wind/air flow during transportation and lessens exposure to damage when the container is being handled. The hook brackets are also preferred to be J-shaped on an end thereof that engages the void in the cornercasting. The J shape may be formed by two 90 degree turns.

The sheet of material is preferred to be formed of a material that is not subject to degradation from weather or UV exposure, and which is tear resistant. Materials such as flexible non woven materials and vinyl materials may be used. Polymer materials such as polyethylene, polypropylene, PET, may be used. The materials should also be receptive to printing, screening or coating indicia thereon.

In one embodiment, the sheet of material formed of vinyl. The vinyl sheet may be formed of various different vinyl weights. In one embodiment, the vinyl is 9-13 oz vinyl, which is suitable for printing indicia and information such as advertising. The sheet of material, which may be vinyl, is formed to fit flush and generally flat against the sides of the container. The sheet of material is formed to endure all modes of container transport including, but not limited to, ocean carry, road transportation, and double stack container trains.

In a preferred embodiment, the sheet of material is rectangular and is formed to have length and width dimensions that are just less than the height and length of the container, so that the sheet of material mounts as shown in the Figures, such as FIG. 2. The dimensions are formed by the position of the cornercastings and the associated brackets that retain the leading bracket and the trailing bracket.

On each of the shorter, vertical sides of the sheet of material, it is preferred to form a bead 14. The bead is an elongated member having sufficient shape retention characteristics or rigidity to hold the bead within the brackets. In one embodiment, a pocket 16 is formed in each end of the sheet of material. The pockets accept and hold the elongated bead. The bead may be formed of a length of plastic, metal or rubber tube or rope that runs the generally the height of each short side. The beads secure the vinyl sheet to each of the brackets. The use of attachment devices, such as magnets 32, which may be flat magnets, may supplement the tensioning of the sheet, and assist in keeping the sheet of material against container.

Pockets 16 may be formed on each vertical end of the sheet of material. Inside the pockets is a bead, which may be a cylindrical and elongated apparatus made of rubber, metal or plastic. The bead is preferred to be generally the same dimension as the end of the sheet, and may be a diameter of about 6-7 mm. The bead allows for the sheet of material, such as a vinyl sheet, to be firmly set within each bracket cavity. The cavities are designed such that most of the length of their opening through which the sheet of material extends is smaller than the width of the bead, to ensure the bead and vinyl are retained within the bracket.

The leading bracket is preferred to have a slot 18, and the trailing bracket is preferred to have a slot 20. The slots receive the vertical ends of the sheet of material, and are preferred to receive the bead. The slots may have an enlarged top opening 24 in one embodiment. The bead slides downward within the slots and is retained.

The trailing bracket is preferred to comprise a generally vertical axle member 26. The generally vertical axle may be used within a ratchet assembly, which provides a winding mechanism for furling the sheet of material. See FIG. 9 and FIG. 11. The axle is preferred to accept a beaded material, such as vinyl, with the bead in a slot that runs substantially the length of the axle. The axle may be used to furl the sheet of material when the sheet of material is not extended along the side of the container.

The leading bracket assembly represents the bracket on the leading edge of the sheet of material. It is preferred that that leading bracket is also the leading end of the ISO container. In one embodiment, whether the container is a tank container, 20 ft, or 40 ft version, the left side bracket is built to retain the vinyl to the front post. This front post will have a mirrored version of itself on the opposite side of the container where the front is considered on the right side. In one embodiment, the assembly comprises two brackets and a rigid rod or tube, which may be an aluminum extrusion, connecting the two. The rod or tube provides a cavity that retains the vinyl bead.

ISO containers are built in varying styles, but for purposes of fitting the leading bracket assembly, there are only two variations, both based on the height. The height of the container is either 8.5 ft or 9.5 feet. The length of the leading bracket assembly is matched to fit the height of the subject container, and allowing the invention to fit virtually every ISO container in the world. The cornercastings at top and bottom also permit the universal use of the invention. The valleys in which the leading and trailing brackets are positioned are also well defined, which also allows universal use of the invention.

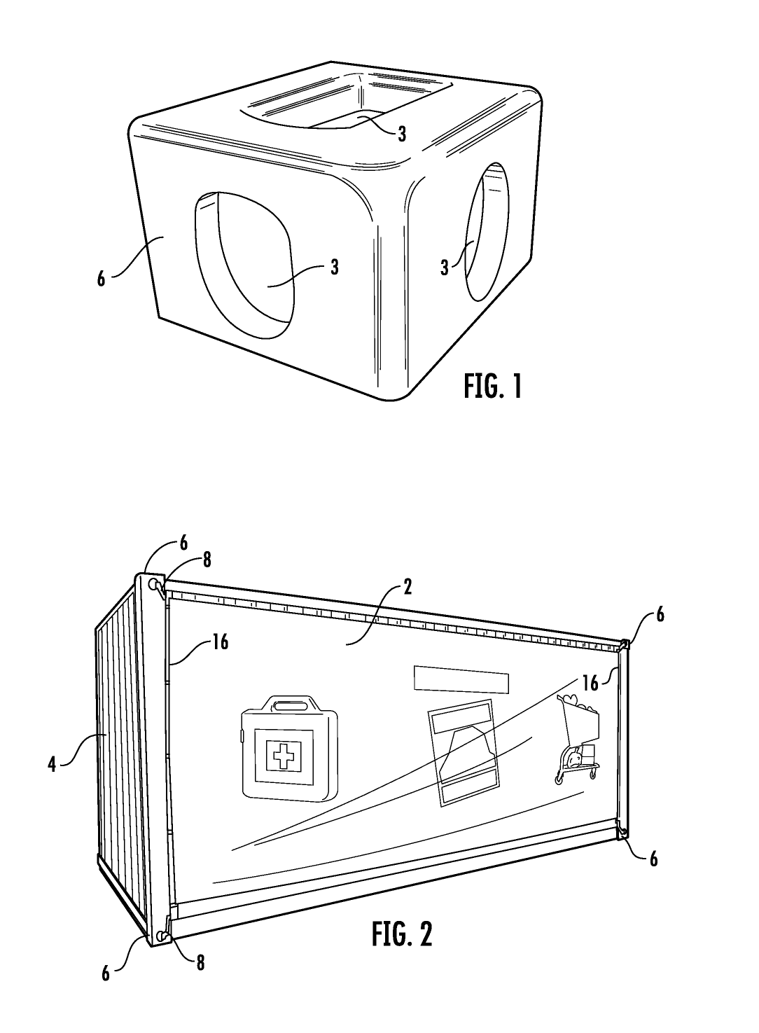

A demonstrative cornercasting is shown in FIG. 1. The cornercasting will have a plurality of voids 3 in the sides. In some cornercastings, the voids are circular. In some cornercastings, the voids are elongated, or oblong. The cornercastings are typically attached, such as by welding, to 4 corners on each side of the container, so that a typical container has 8 cornercastings. The corner castings are used in the prior art as lifting points for the container or as attachment points for lashing a group of containers.

A ratchet assembly may be used as part of the winding mechanism for the trailing bracket of the ISO container. The trailing bracket is preferred to retain the sheet of material, and to pull the sheet of material to a generally stiff, taut position when the sheet of material is extended along the side of the container, and the leading edge is positioned in the leading bracket. This formation of the sheet of material adapts it for travel and resistance to weather and wind. This trailing post may have a “mirrored” version on the opposite side of the container, wherein the trailing edge is on the left side.

A cable may be used that diagonally connects one corner casting to another cornercasting. The cable runs from an upper cornercasting to an opposite lower casting, and is positioned between the side of the container and the unfurled sheet of material that is present in the leading bracket. The cable may be used in pairs to form an X. The cable provides support for the sheet of material.

Holes or voids may be formed in the sheet of material to allow air to flow through the sheet of material. The holes are preferred to be formed to prevent tearing or enlarging of the hole from air flow.

In one embodiment, the trailing bracket assembly comprises:
1. Two hook brackets 8 as shown in the Figures.
2. A generally rigid and elongated member, which may be aluminum extrusion, which connects the hook brackets. This may resemble an “L” shaped extrusion.
3. A vertical, rotating axle that runs the height of the generally rigid and elongated member, which may be cylindrical or extruded in another shape.
4. Retaining members, which may Inner tubes that retain the axle to the top and attached to the winch at bottom.
5. A winding mechanism for winding the sheet of material and pulling it taught used in combination with the above described elements, and which may be a winch and pawl assembly.

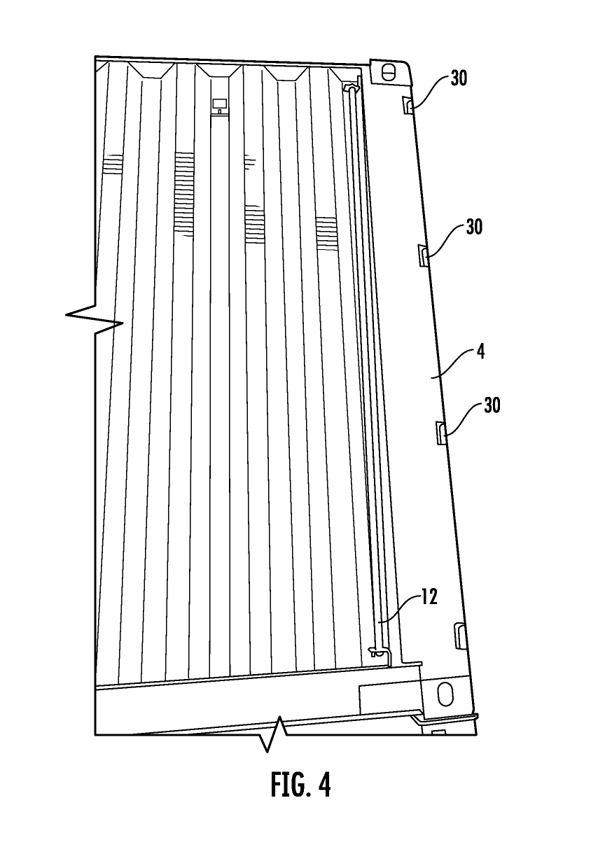

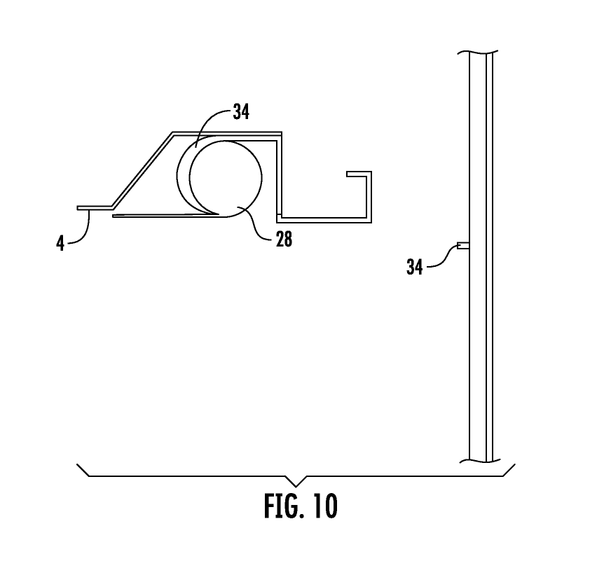

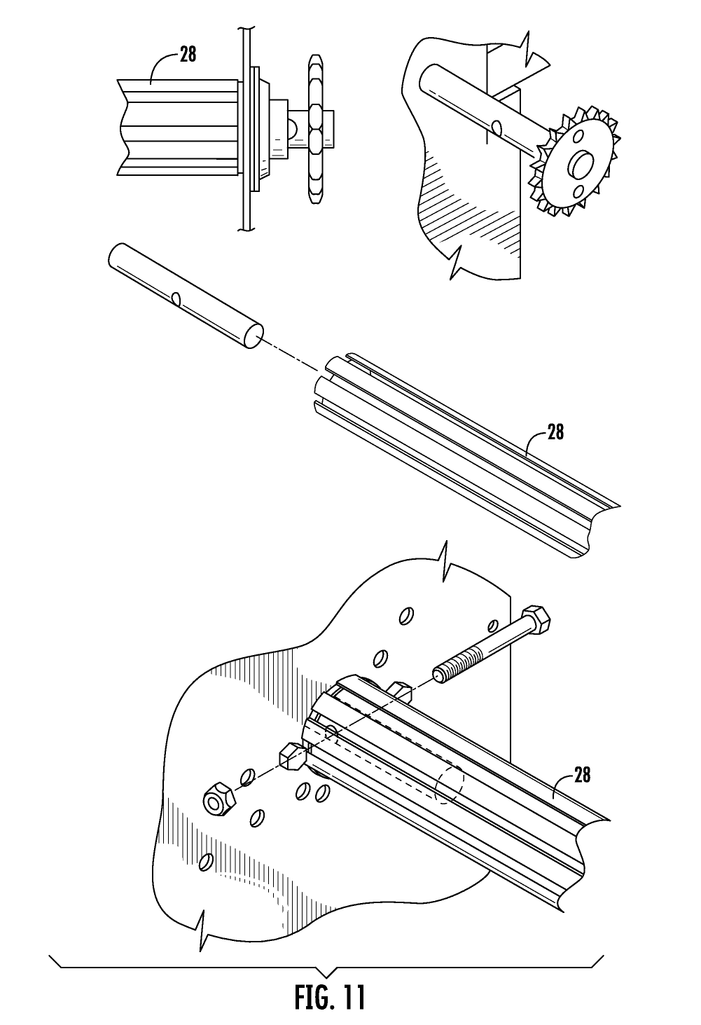

In another embodiment, the trailing bracket assembly comprises:
1. Additional brackets that are attach to door hinge pockets 30 on the trailing end of the container. See FIG. 4
2. Replacement brackets that may be connected to the door hinge pockets. See FIG. 4
3. A retention hook 34 for the rotating axle. This retention hook retards deflection and bending to deformation of the rotating axle when the rotating axle is under the pressure of the taut vinyl. See FIG. 10.

The axle may tend to deflect due to its length and the pressure applied by rotation or by tension on the sheet of material that is transferred to the axle. The optional retention hook is preferred to have an arcuate surface that retards deflection of the axle, while providing a bearing surface for rotation of the axle. FIG. 10. The optional retention hook is, in one embodiment, mounted about halfway along the length of the vertically mounted axle. The axle is shown as recessed within a valley in a side of a corrugated sided container 4.

In another embodiment, the sheet or material, such as vinyl, may be attached to the container by means other than the bead arrangement. A sewn ratchet system attaches the sheet of material, such as vinyl, to customized brackets. These brackets may attach to each of the four corner castings seamlessly, as they are built to fit ISO standard measurements. The vinyl may be cut to a substantially exact measurement, and sufficiently stretched to place the attached hook into the corner casting. The sheet of material is sufficiently tensioned to withstand air forces on the highway while the container is transported at highway speeds. The use of ancillary attachment devices, such as magnets or flat magnets may be used to supplement the tensioned sheet of material in holding flat against container.

In yet another embodiment, the sheet of material, such as vinyl, may be attached to the container utilizing a similar sewn ratchet system into the sheet of material on the right end, but having a flat hook on the other end. The flat hooks may be placed into the pockets 30 that are present on the side of the container for the door hinges. See FIG. 4. The sheet of material is cut to a substantially exact measurement and sufficiently stretched to place the flat hook into the door hinge pocket. The sheet of material is sufficiently tensioned to withstand air forces when the container is travelling at highway speeds. The use of ancillary attachment devices, such as magnets or flat magnets may be used to supplement the tensioned sheet of material in holding flat against container.

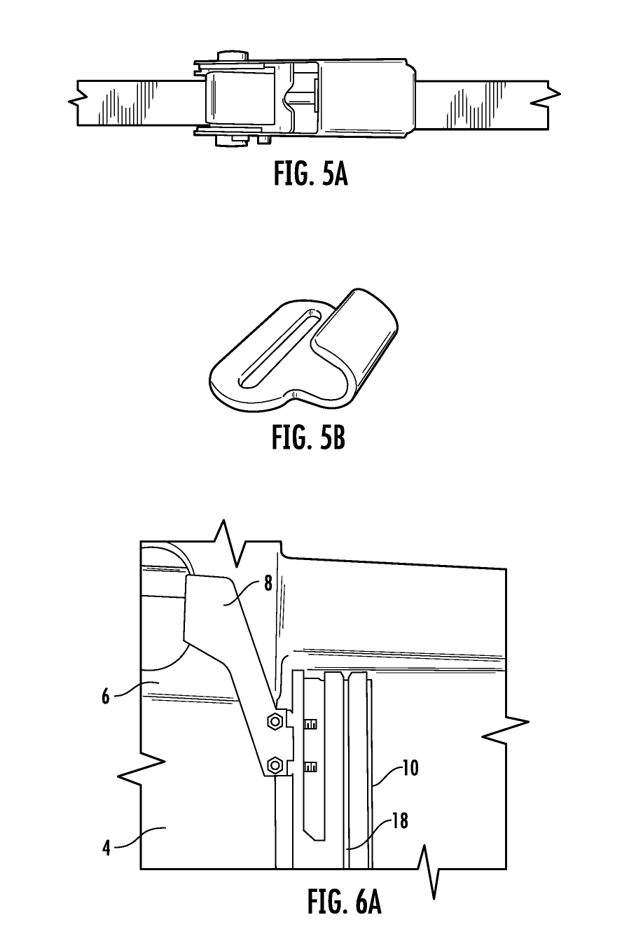

A hook suitable for engaging the pockets 30 is shown in FIG. 5B. An alternative buckle mechanism for tightening a strap that can be used to tension the sheet of material is shown in FIG. 5A.

In one embodiment, the ratchet is pre-constructed and sewn into the sheet of material in multiple places, such as 2-4 different places, on the right side of the sheet of material. FIG. 2. The opposite strap on the ratchet will connect to either custom brackets for cornercastings, or flat hooks for door hinge receptacles.

In another embodiment, the sheet of material is tightened by a tool that is not part of the assembly that is affixed to the container. This embodiment utilizes the hook brackets to engage each of the four cornercastings on a side of the container. These brackets attach to the sheet of material by using a similar channel that is utilized on the leading bracket in the primary design, except that it is present at both ends. The sheet of material is cut to a length that is just short of covering the entire edge of the container without being tightened. This length allows the sheet of material to be perfectly taut when it is stretched to attach to the brackets on each end.

Installation of this embodiment prefers to insert the leading end hook brackets into the corresponding cornercastings. Next, the leading bracket bead is positioned into the cavity of the leading bracket. The trailing end bead is inserting into the trailing bracket cavity. The brackets may be positioned into the trailing cornercastings utilizing a C clamp tool, bringing the top and bottom brackets close to the corner castings, and then progressively inserting them into the cornercastings. The C Clamp may utilize the trailing end of the container on one end, and a small fitting on the bracket on the other, for leverage in stretching the vinyl. This particular embodiment has particular utility with refrigerated containers, which may be about forty (40) feet or about twenty (20) feet in length. Typically, there is no corrugation in the siding of a refrigerated container, meaning there is no space for a ratchet bracket assembly, and tensioning is suited to use of a C-clamp device. See Figure A. Another embodiment is similar to the C Clamp device described above. This embodiment utilizes the door hinges on the trailing end to hold brackets, instead of using the cornercastings

This invention may be used on container configurations that include Standard (with lengths of 20 to 53 ft), High Cube (with lengths of 40 to 53 ft); refrigerated, open top and tank-type containers.

The brackets utilized for attachment to the cornercastings conform to the container. By way of example, containers built primarily for rail travel are preferred to have different sized brackets than those for traditional shipping containers. While a vast majority of containers for shipping are the same as those transported by rail, there are variations. Containers used for rail transport, such as Crowley, Horizon and CSX assets, utilize traditional corner castings, but such corner castings may be positioned differently in context with their distance from the corrugated valleys. Some transportation companies, such as JB Hunt, have developed their own corner castings for rail. Brackets may be adapted to fit these variations, although they represent a comparatively small percentage of the world container fleet.

In some preferred embodiments, an axle is used in the assembly of the ratchet edge bracket. Another variation of a rotating axle utilizes stub shafts for both retaining the top end and attaching the winch at the bottom. FIG. 11.

In preferred embodiments, the invention comprises three (3) primary parts:
1. A sheet of flexible material that may be wound about itself or furled on an axle, such as a vinyl sheet as disclosed;
2. Leading hook brackets
3. Trailing hook brackets, preferably having an associated winding mechanism

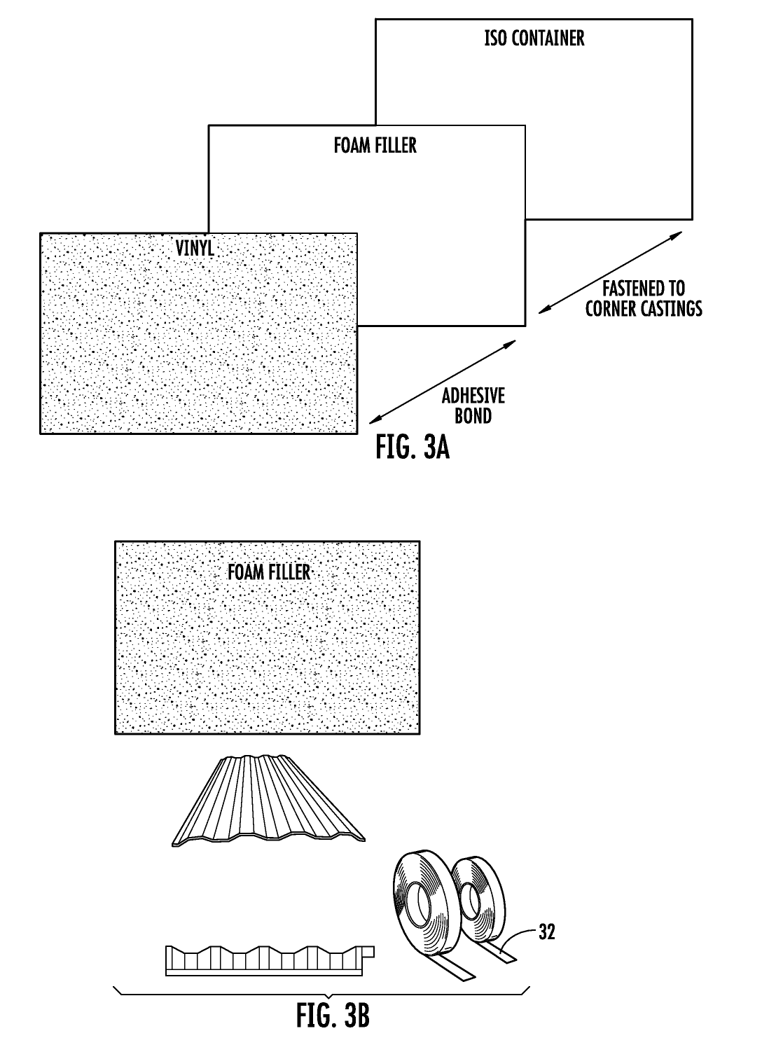

Preferred embodiments may additionally comprise:
1. A resilient backing material, such as foam material, that engages corrugation on the side of the container to seal out any vacuum space underneath the vinyl. See FIG. 3.
2. Attachment devices along the length of the sheet of material that have an affinity for the side of the container, such as magnets, which may be thin magnetic stripping. The attachment devices hold the sheet of material relatively flush with container side.

The invention may be used to form and attach signs, which are preferred in one embodiment to be formed as banners. The banners may comprise a water proof substrate, such as vinyl, having sufficient thickness to resist tearing when mounted to a truck travelling at highway speeds, as described herein. The banners may be printed with indicia, such as advertising or informational messages. The banners may be printed in monochrome, or in multiple colors, or may be printed using full color process using known printing methods. Digital printing methods allow full color images to be printed, and the image may be custom designed and produced so that as few as one banner of a particular image may be economically printed.

A preferred ‘soft signage’ substrate may be formed of woven or non-woven fabrics that may be blended and/or laminated with polymeric materials or fillers. Some water proof or water resistant textiles that meet the goals of the invention materials are suitable. The sign or banner may be printed with inks, such as solvent based and UV curable inks.

What is claimed is:

1. A display for removable attachment to sides of shipping containers, comprising
a) a sheet of material, wherein said sheet of material is constructed and arranged to be wound about itself, and the sheet of material has indicia formed thereon;
b) a leading bracket, wherein the leading bracket comprises a generally vertical elongated member that is constructed and arranged to receive and hold a leading end of the sheet of material, and the elongated member comprises a first hook bracket that is positioned near an upper end of the vertical member and the first hook bracket is constructed and arranged to be inserted within and held within a cornercasting of a shipping container and the elongated member comprises a second hook bracket that is positioned near an lower end of the vertical member and the second hook bracket is constructed and arranged to be inserted within and held within a cornercasting of a shipping container;
c) a trailing bracket that is constructed wherein the trailing bracket comprises an elongated vertical axle member positioned near an upper end of the trailing bracket that is constructed and arranged to receive and hold an end of the sheet of material, the trailing bracket comprising a first hook bracket positioned near an upper end of the elongated vertical axle member, the first hook bracket constructed and arranged to be inserted within and held within a cornercasting of a shipping container and the trailing bracket comprising a second hook bracket positioned near a lower end of the elongated vertical axle member, the second hook bracket constructed and arranged to be inserted within and held within a cornercasting of a shipping container, and
a winding mechanism that communicates with the elongated vertical axle member to rotate the elongated vertical axle member and the sheet of material.

2. The display for removable attachment to sides of shipping containers as described in claim 1, wherein the sheet of material is formed and constructed to cover substantially all of a rectangular portion of a side of a shipping container, wherein the rectangular portion of the side of the shipping container is defined by four corner castings of the shipping container.

3. The display for removable attachment to sides of shipping containers as described in claim 1, wherein each of the first hook bracket and the second hook bracket of the leading bracket and the first hook bracket and the second hook bracket of the trailing bracket are each formed and constructed to be substantially flush against the side of the shipping container.

4. The display for removable attachment to sides of shipping containers as described in claim 1, wherein each of the first hook bracket and the second hook bracket of the leading bracket and the first hook bracket and the second hook bracket of the trailing bracket are each formed and constructed to be substantially flush against the side of the shipping container, and the first hook bracket and the second hook bracket of the leading bracket position the leading bracket within a recess formed in the side of the shipping container and the first hook bracket and the second hook bracket of the trailing bracket position the trailing bracket within a recess formed in the side of the shipping container.

5. The display for removable attachment to sides of shipping containers as described in claim 1, wherein the sheet of material comprises an elongated and vertical bead formed on the leading edge of the sheet of material, and the generally vertical elongated member comprises a generally vertical slot formed therein for receiving and holding the elongated and vertical bead.

6. The display for removable attachment to sides of shipping containers as described in claim 1, wherein the sheet of material comprises an enclosed pocket formed on the leading edge of the sheet of material, and the enclosed pocket comprises an elongated vertical bead contained therein, and the generally vertical elongated member comprises a generally vertical slot formed therein for receiving and holding the elongated and vertical bead.

7. The display for removable attachment to sides of shipping containers as described in claim 1, wherein the sheet of material comprises an elongated and vertical bead formed on the leading edge of the sheet of material, and the generally vertical elongated member comprises a generally vertical slot formed therein for receiving and holding the elongated and vertical bead, and wherein the elongated and vertical bead engages the generally vertical slot of the generally vertical elongated member.

8. The display for removable attachment to sides of shipping containers as described in claim 1, further comprising a backing material that is constructed and arranged to be positioned between the sheet of material and a side of a shipping container.

9. The display for removable attachment to sides of shipping containers as described in claim 1, further comprising a backing material that is constructed and arrayed to be positioned between the sheet of material and a side of a shipping container, wherein the backing material comprises a peak and a valley on a side thereof, wherein the peak is constructed and arranged to engage a valley of the side of the shipping container and the valley is constructed and arranged to engage a peak of the side of the shipping container.

10. The display for removable attachment to sides of shipping containers as described in claim 1, wherein the winding mechanism that communicates with the elongated vertical axle member to rotate the elongated vertical axle member and the sheet of material comprises a ratchet.

11. The display for removable attachment to sides of shipping containers as described in claim 1, wherein the sheet of material is formed and constructed to cover substantially all of a recessed and rectangular portion of a side of a shipping container, wherein the recessed and rectangular portion of the side of the shipping container is defined by four corner castings of the shipping container.

12. The display for removable attachment to sides of shipping containers as described in claim 1, wherein a leading edge of the sheet of material is fixed to the leading bracket and the opposite end of the sheet of material is fixed to the trailing bracket.

13. The display for removable attachment to sides of shipping containers as described in claim 1, wherein the first hook bracket and the second hook bracket of the leading bracket position the leading bracket within a recess formed in the side of the shipping container and the first hook bracket and the second hook bracket of the trailing bracket position the trailing bracket within a recess formed in the side of the shipping container.

14. The display for removable attachment to sides of shipping containers as described in claim 1, further comprising a magnet, wherein the magnet is positioned to hold an intermediate portion of the sheet of material against the side of the shipping container.
